(19) United States
(12) Patent Application Publication
(10) Pub. No.: US 2017/0033339 A1
(43) Pub. Date: Feb. 2, 2017

(54) ELECTRICITY STORAGE SYSTEM

(71) Applicant: TOYOTA JIDOSHA KABUSHIKI KAISHA, Toyota-shi, Aichi-ken (JP)

(72) Inventors: Hirotaka WATANABE, Toyota-shi (JP); Junta KATAYAMA, Miyoshi-shi (JP); Kenji KIMURA, Miyoshi-shi (JP); Takaaki YOKOI, Kitanagoya-shi (JP)

(73) Assignee: TOYOTA JIDOSHA KABUSHIKI KAISHA, Toyota-shi, Aichi-ken (JP)

(21) Appl. No.: 15/303,665

(22) PCT Filed: Apr. 9, 2015
(86) PCT No.: PCT/IB2015/000456

§ 371 Date: Oct. 12, 2016

(30) Foreign Application Priority Data
Apr. 23, 2014 (JP) 2014-089343

(51) Int. Cl. H01M 2/10; H01G 11/28; H01G 11/76; H01G 11/10; H01G 11/78

(52) U.S. Cl. CPC H01M 2/1077; H01M 2/1083; H01G 11/10; H01G 11/78; H01G 11/76; H01G 11/28; H01M 2220/20

(57) ABSTRACT

An electricity storage system includes a plurality of electricity storage elements, a partition member, a pair of end plates, and a plurality of coupling members. The case includes a flat surface that has a first region opposed to a positive-electrode active material layer and a negative-electrode active material layer of a power generation element, and a second region other than the first region. The partition member is disposed between two electricity storage elements adjacent to each other in the predetermined direction. The pair of end plates is disposed in positions sandwiching the plurality of electricity storage elements in the predetermined direction such that the pair of end plates applies a constraint force to the plurality of electricity storage elements. The constraint force acting on the second region is larger than the constraint force acting on the first region.

### BACKGROUND OF THE INVENTION

1. Field of the Invention

The invention relates to an electricity storage system having a structure that applies a constraint force to a plurality of electricity storage elements.

2. Description of Related Art

In a power supply device described in Japanese Patent Application

Publication No. 2013-178894 (JP 2013-178894 A), a plurality of square battery cells are stacked in a predetermined direction and a spacer is disposed between two square battery cells adjacent to each other. A pair of end plates is disposed at both ends of the power supply device in the predetermined direction. A bind bar extending in the predetermined direction is coupled to the pair of end plates. When the power supply device is assembled, an interval between the pair of end plates is fixed, and a predetermined constraint force is applied to the square battery cells via the spacer. In JP 2013-178894 A, a pressing section of the spacer presses the centers of wide surfaces in outer cans of the square battery cells and suppresses expansion of the square battery cells.

### SUMMARY OF THE INVENTION

In JP 2013-178894 A, power generation elements are housed in the outer cans of the square battery cells. The power generation elements expand and contract according to charging and discharging. When the temperature of the power generation elements changes, the power generation elements sometimes also expand and contract.

Such expansion and contraction of the power generation elements are caused by a volume change of active material layers included in the power generation elements. In JP 2013-178894 A, regions where the spacer is in contact with the outer cans (the centers of the wide surfaces of the outer cans) are deformed according to the expansion and the contraction of the power generation elements. The spacer is susceptible to action due to the expansion and the contraction of the power generation elements.

In the power supply device described in JP 2013-178894 A, the interval between the pair of end plates is fixed as explained above. Therefore, when the power generation elements contract, the constraint force applied to the square battery cells from the spacer decreases. When the constraint force to the square battery cells decreases, the square battery cells easily shift when an external force is applied to the power supply device. The square battery cells cannot be fixed in predetermined positions. The invention provides an electricity storage system that suppresses, when power generation elements contract, electricity storage elements from shifting even when a constraint force to the electricity storage elements decreases.

An electricity storage system according to an aspect of the invention includes a plurality of electricity storage elements, a partition member, a pair of end plates, and a plurality of coupling members. The plurality of electricity storage elements are disposed side by side in a predetermined direction. The electricity storage element each include a power generation element and a case. The power generation element is configured to perform charging and discharging. The power generation element includes a positive electrode plate in which a positive-electrode active material layer is provided on a current collector and a negative electrode plate in which a negative-electrode active material layer is provided on a current collector. The case houses the power generation element. The case includes a flat surface orthogonal to the predetermined direction. The flat surface includes a first region opposed to the positive-electrode active material layer and the negative-electrode active material layer of the power generation element in the predetermined direction, and a second region other than the first region.

The partition member is disposed between two electricity storage elements adjacent to each other in the predetermined direction. The pair of end plates is disposed in positions sandwiching the plurality of electricity storage elements in the predetermined direction such that the pair of end plates applies a constraint force in the predetermined direction to the plurality of electricity storage elements. The constraint force acting on the second region is larger than the constraint force acting on the first region, on the flat surface of at least one of the two electricity storage elements adjacent to each other in the predetermined direction.

According to the aspect, since the first region is opposed to the positive-electrode active material layer and the negative-electrode active material layer, the first region is easily deformed by being affected by a volume change (expansion and contraction of the power generation element) in the positive-electrode active material layer and the negative-electrode active material layer. The constraint force acting on the second region is larger than the constraint force acting on the first region irrespective of the expansion and the contraction of the power generation element. Consequently, even if the first region is deformed by the expansion and contraction of the power generation element, it is possible to suppress the influence on the constraint force acting on the first region. It is possible to continue to apply a predetermined (fixed) constraint force to the electricity storage elements in the second region. Consequently, for example, when the power generation element contracts, it is possible to suppress a situation in which the constraint force to the electricity storage elements decreases and the electricity storage elements shift. In the electricity storage system according to the aspect, the constraint force may act on the flat surface from the partition member. In the electricity storage system, the constraint force may act on the flat surface from the pair of end plates. Irrespective of whether the constraint force acts on the flat surface from the partition member or acts on the flat surface from the pair of end plates, it is possible to suppress the influence on the constraint force acting on the first region. It is possible to continue to apply the predetermined (fixed) constraint force to the electricity storage elements in the second region.

In the electricity storage system according to the aspect, the partition member may be set in contact within the second region without being set in contact with the first region, on the flat surface of at least one of the two electricity storage elements adjacent to each other in the predetermined direction. If the partition member is not set in contact with the first region irrespective of the expansion and the contraction of the power generation element, even if the expansion and the contraction of the power generation elements occur, it is possible to prevent the constraint force from acting on the first region. Consequently, it is possible to allow deformation of the first region corresponding to the expansion and the contraction of the power generation element while continuing to apply the predetermined (fixed) constraint force from the partition member to the electricity storage elements using the second region.

In the electricity storage system according to the aspect, the plurality of coupling members may include a pair of the coupling members disposed in positions sandwiching the electricity storage elements in a plane orthogonal to the predetermined direction. A part of the second region may extend from one of the pair of coupling members to the other in the plane orthogonal to the predetermined direction. A region of the partition member that is in contact with the second region may extend on a straight line that connects the pair of coupling members in the plane orthogonal to the predetermined direction.

A constraint force generated by coupling the pair of coupling members to the pair of end plates mainly acts in a plane including the pair of coupling members. In the plane, the straight line that connects the pair of coupling members is located. According to this aspect, it is easy to cause the constraint force to act on the second region from the partition member by extending, on the straight line that connects the pair of coupling members, the region of the partition member that is in contact with the second region. Consequently, it is possible to apply a predetermined constraint force to the second region from the partition member even if an excessive constraint force is not generated by the coupling of the coupling members and the end plates.

In the electricity storage system according to the aspect, the partition member may be configured by a main body section, a flange, and a protrusion section. The main body section may be opposed to the flat surface of the case in the predetermined direction. The flange may position the electricity storage elements in the plane orthogonal to the predetermined direction. The protrusion section may project from the main body section in the predetermined direction and may be in contact with the second region at a distal end of the protrusion section. According to this aspect, if the electricity storage elements are positioned using the flange, the protrusion section can be set in contact with the second region without shifting.

In the electricity storage system according to the aspect, it is possible to set the end plates in contact within the second region without setting the end plates in contact with the first region. If the end plates are not set in contact with the first region irrespective of the expansion and the contraction of the power generation element, it is possible to prevent the constraint force from acting on the first region even if the expansion and the contraction of the power generation element occur. Consequently, it is possible to allow deformation of the first region according to the expansion and the contraction of the power generation element while continuing to apply the predetermined (fixed) constraint force to the electricity storage elements from the end plates using the second region.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is an external view of a battery stack;

FIG. 2 is a diagram showing the internal structure of a single battery;

FIG. 3 is a development view of a power generation element;

FIG. 4 is an external view of the power generation element;

FIG. 5 is a diagram for explaining a region with which a partition member is in contact in the single battery;

FIG. 6A is a front view of the partition member;

FIG. 6B is a VIB-VIB sectional view of FIG. 6A;

FIG. 7 is a front view of the partition member;

FIG. 8 is a front view of the partition member;

FIG. 9 is a front view of the partition member;

FIG. 10 is a front view of the partition member;

FIG. 11 is a front view of the partition member;

FIG. 12 is a front view of the partition member;

FIG. 13 is an external view of the partition member;

FIG. 14 is a sectional view of the partition member;

FIG. 15 is a diagram showing a positional relation between the single battery and coupling members;

FIG. 16 is a diagram showing a positional relation between the single battery and coupling members;

FIG. 17 is an external view of an end plate; and

FIG. 18 is a diagram showing a structure that constrains the single battery using a pair of end plates.

### DETAILED DESCRIPTION OF EMBODIMENTS

An embodiment of the invention is explained below.

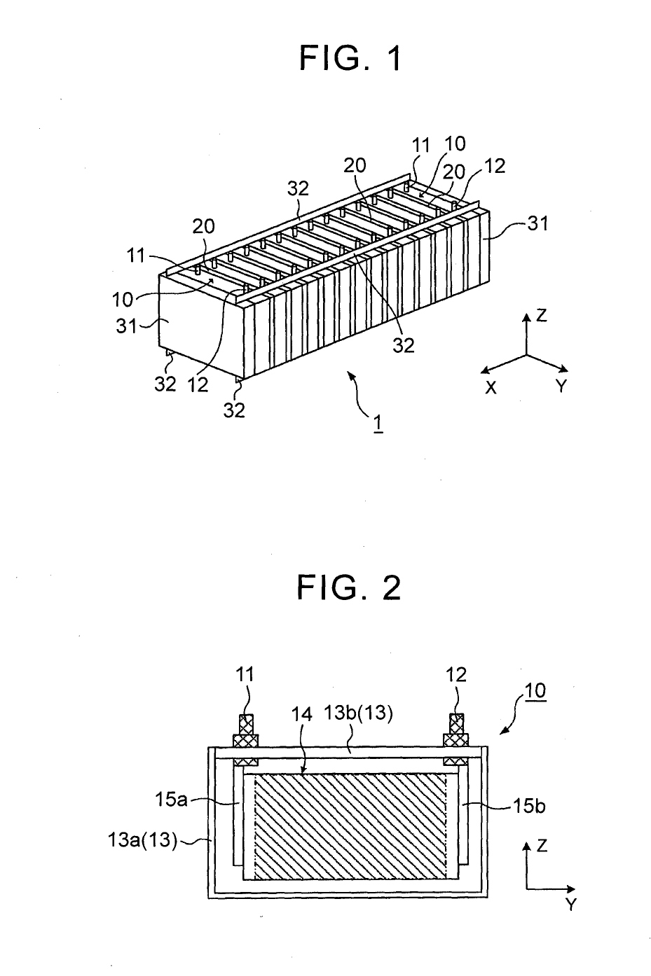

The structure of a battery stack of this embodiment (equivalent to the electricity storage system of the invention) is explained with reference to FIG. 1. In FIG. 1, an X axis, a Y axis, and a Z axis are axes orthogonal to one another. In this embodiment, an axis equivalent to the vertical direction is the Z axis. A relation among the X axis, the Y axis, and the Z axis is the same in the other drawings.

A battery stack 1 includes a plurality of single batteries (equivalent to the electricity storage elements of the invention) 10. The plurality of single batteries 10 are arranged in an X direction (equivalent to the predetermined direction of the invention). Positive electrode terminals 11 and negative electrode terminals 12 are provided on the upper surface of the single batteries 10. For example, the plurality of single batteries 10 can be connected in series via the positive electrode terminals 11 and the negative electrode terminals 12.

Specifically, concerning two single batteries 10 adjacent to each other in the X direction, by connecting a bus bar (not shown in the figure) to the positive electrode terminal 11 of one single battery 10 and the negative electrode terminal 12 of the other single battery 10, the plurality of single batteries 10 can be connected in series. As the single battery 10, a secondary battery such as a nickel-hydrogen battery or a lithium ion battery can be used. Instead of the secondary battery, an electric double layer capacitor can be used.

A partition member 20 is disposed between the two single batteries 10 adjacent to each other in the X direction. The partition member 20 can be formed by an insulating material such as resin. As explained below, a part of the partition member 20 is in contact with the single battery 10. In a region where the single battery 10 and the partition member 20 are not in contact, a space is formed between the single battery 10 and the partition member 20.

A pair of end plates 31 is disposed at both the ends of the battery stack 1 in the X direction. That is, in the X direction, the pair of end plates 31 sandwiches all the single batteries 10 configuring the battery stack 1. The pair of end plates 31 is used to apply a constraint force to the plurality of single batteries 10. By displacing the pair of end plates 31 in a direction in which the pair of end plates 31 comes close to each other (the X direction), the constraint force can be applied to the plurality of single batteries 10 sandwiched by the pair of end plates 31.

The constraint force is a force for holding the respective single batteries 10 in the X direction. The battery stack 1 includes the single battery 10 sandwiched by the two partition members 20 and the single battery 10 sandwiched by the partition member 20 and the end plate 31. The single battery 10 sandwiched by the two partition members 20 receives the constraint force from the partition members 20. The single battery 10 sandwiched by the partition member 20 and the end plate 31 receives the constraint force from each of the partition member 20 and the end plate 31.

Both the ends of a coupling member 32 extending in the X direction are respectively coupled to the pair of end plates 31. The end plates 31 and the coupling member 32 can be coupled using fastening members such as bolts or rivets or can be coupled by welding or the like. As shown in FIG. 1, two coupling members 32 are disposed on each of the upper surface and the lower surface of the battery stack 1. The two coupling members 32 disposed on the upper surface of the battery stack 1 are disposed in positions where the coupling members 32 do not interfere with the positive electrode terminals 11 and the negative electrode terminals 12.

By coupling the coupling members 32 to the pair of end plates 31, the pair of end plates 31 can be displaced in the direction in which the pair of end plates 31 comes close to each other (the X direction). Consequently, as explained above, the constraint force can be applied to the plurality of single batteries 10. Since the constraint force only has to be able to be applied to the plurality of single batteries 10, positions where the coupling members 32 are disposed and the number of the coupling members 32 can be set as appropriate taking into account this point.

The structure of the single battery 10 is explained with reference to FIG. 2.

The single battery 10 includes a battery case (equivalent to the case of the invention) 13 and a power generation element 14 housed in the battery case 13. The battery case 13 is formed in a shape extending along a rectangular parallel piped and includes a case main body 13a and a lid 13b. The case main body 13a includes an opening for incorporating the power generation element 14 into the case main body 13a. The opening is closed by the lid 13b.

By fixing the lid 13b to the case main body 13a, the inside of the battery case 13 changes to a closed state. The lid 13b configures the upper surface of the battery case 13 (the single battery 10). The positive electrode terminal 11 and the negative electrode terminal 12 are fixed to the lid 13b and pierce through the lid 13b.

The power generation element 14 is an element that performs charging and discharging. A positive electrode tab 15a and a negative electrode tab 15b are connected to the power generation element 14. The positive electrode tab 15a is also connected to the positive electrode terminal 11. The negative electrode tab 15b is also connected to the negative electrode terminal 12. Consequently, by connecting the positive electrode terminal 11 and the negative electrode terminal 12 to a load, the power generation element 14 can be charged and discharged. The power generation element 14 is fixed to the lid 13b via the positive electrode tab 15a, the negative electrode tab 15b, the positive electrode terminal 11, and the negative electrode terminal 12. Therefore, the power generation element 14 is positioned on the inside of the battery case 13.

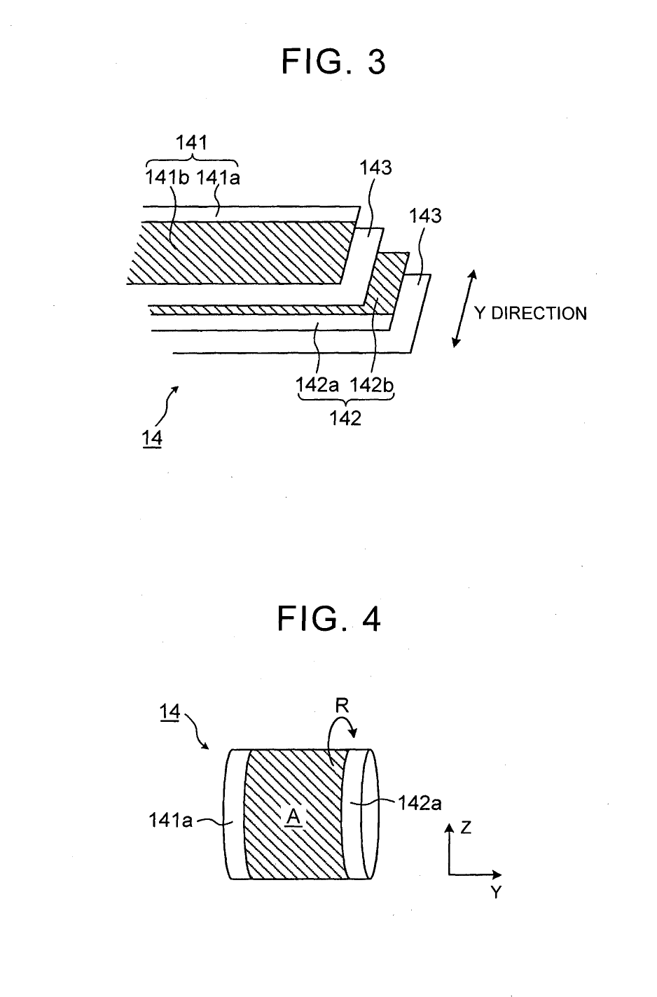

The structure of the power generation element 14 is explained with reference to FIGS. 3 and 4. FIG. 3 is a development view of a part of the power generation element 14. FIG. 4 is an external view of the power generation element 14.

The power generation element 14 includes a positive electrode plate 141, a negative electrode plate 142, and a separator 143. The positive electrode plate 141 includes a current collector 141a and a positive-electrode active material layer 141b provided on the surface (both the surfaces) of the current collector 141a. The positive-electrode active material layer 141b includes a positive electrode active material, a conductive agent, and a binder. The positive-electrode active material layer 141b is provided in a part of a region of the current collector 141a. The other region of the current collector 141a is exposed. The exposed region is located at one end of the current collector 141a in the Y direction.

The negative electrode plate 142 includes a current collector 142a and a negative-electrode active material layer 142b provided on the surface (both the surfaces) of the current collector 142a. The negative-electrode active material layer 142b includes a negative electrode active material, a conductive agent, and a binder. The negative-electrode active material layer 142b is provided in a part of a region of the current collector 142a. The other region of the current collector 142a is exposed. The exposed region is located at the other end of the current collector 142a in the Y direction. The positive-electrode active material layer 141b, the negative-electrode active material layer 142b, and the separator 143 are impregnated with electrolytic solution.

The positive electrode plate 141, the negative electrode plate 142, and the separator 143 are stacked in order shown in FIG. 3. A stacked body of the positive electrode plate 141, the negative electrode plate 142, and the separator 143 is wound in a direction indicated by an arrow R in FIG. 4, whereby the power generation element 14 is configured. In FIG. 4, only the current collector 141a of the positive electrode plate 141 is wound at one end of the power generation element 14 in the Y direction. As explained with reference to FIG. 2, the positive electrode tab 15a is connected to the current collector 141a. Only the current collector 142a of the negative electrode plate 142 is wound at the other end of the power generation element 14 in the Y direction. As explained with reference to FIG. 2, the negative electrode tab 15b is connected to the current collector 142a.

A region A shown in FIG. 4 is a region where at least one of the positive-electrode active material layer 141b and the negative-electrode active material layer 142b is located and is a region participating in expansion and contraction of the power generation element 14. The expansion and the contraction of the power generation element 14 mainly depends on a volume change of the positive-electrode active material layer 141b and the negative-electrode active material layer 142b. Therefore, the region (the region A) where the positive-electrode active material layer 141b and the negative-electrode active material layer 142b are disposed can be considered the region participating in the expansion and the contraction of the power generation element 14.

The power generation element 14 expands and contracts according to charging and discharging of the power generation element 14. Specifically, when the power generation element 14 is charged and discharged, a reaction participating substance moves between the positive-electrode active material layer 141b and the negative-electrode active material layer 142b, whereby a volume change occurs in the positive-electrode active material layer 141b and the negative-electrode active material layer 142b. The reaction participating substance is a substance participating in the charging and the discharging of the power generation element 14. For example, when a lithium ion secondary battery is used as the single battery 10, the reaction participating substance is lithium ion.

On the other hand, the volume change of the positive-electrode active material layer 141b and the negative-electrode active material layer 142b also depends on the temperature of the power generation element 14. Therefore, the power generation element 14 expands and contracts according to a change in the temperature of the power generation element 14.

Depending on the structure of the power generation element 14, the entire positive-electrode active material layer 141b is sometimes opposed to the entire negative-electrode active material layer 142b via the separator 143.

On the other hand, depending on the structure of the power generation element 14, the length of the positive-electrode active material layer 141b in the Y direction and the length of the negative-electrode active material layer 142b in the Y direction are sometimes different from each other. The positive-electrode active material layer 141b (or the negative-electrode active material layer 142b) sometimes shifts in the Y direction with respect to the negative-electrode active material layer 142b (or the positive-electrode active material layer 141b).

In this case, the positive-electrode active material layer 141b sometimes includes a region opposed to the negative-electrode active material layer 142b (referred to as opposed region) and a region not opposed to the negative-electrode active material layer 142b (referred to as unopposed region). Alternatively, the negative-electrode active material layer 142b sometimes includes a region opposed to the positive-electrode active material layer 141b (referred to as opposed region) and a region not opposed to the positive-electrode active material layer 141b (referred to as unopposed region). The region A includes not only the opposed region but also the unopposed region.

Note that, in this embodiment, the power generation element 14 is configured by winding the stacked body obtained by stacking the positive electrode plate 141, the negative electrode plate 142, and the separator 143. However, the power generation element 14 is not limited to this. Specifically, the power generation element 14 can also be configured by simply stacking the positive electrode plate 141, the negative electrode plate 142, and the separator 143. In this embodiment, the electrolytic solution is used. However, a solid electrolyte can be used instead of the electrolytic solution. In this case, the solid electrolyte only has to be disposed instead of the separator 143.

A region where the single battery 10 and the partition member 20 are in contact with each other is explained.

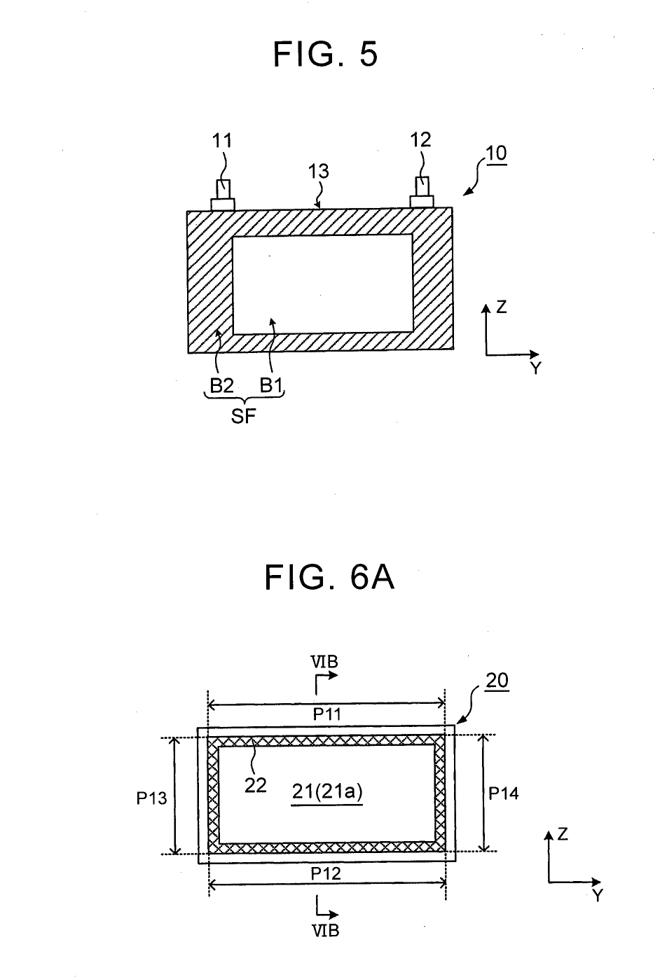

FIG. 5 shows a region with which the partition member 20 can be set in contact on a side surface SF of the battery case 13. The side surface SF of the battery case 13 is a part of the case main body 13a and is a flat surface located in a plane (a Y-Z plane) orthogonal to the X direction. Both the end faces of the battery case 13 in the X direction are side surfaces SF. The power generation element 14 is disposed between a pair of side surfaces SF.

The side surface SF includes a noncontact region (equivalent to the first region of the invention) B1 and a contact region (equivalent to the second region of the invention) B2. The noncontact region B1 is a region opposed to the region A of the power generation element 14 in the X direction. That is, a region formed when the region A is projected on the side surface SF in the X direction is the noncontact region B1.

On the other hand, the contact region B2 is a region excluding the noncontact region B1 in the side surface SF. The partition member 20 is in contact with at least a part of the contact region B2. As explained above, the power generation element 14 is positioned on the inside of the battery case 13. Therefore, the noncontact region B1 and the contact region B2 can be specified.

The partition member 20 only has to be in contact with at least a part of the contact region B2. The position with which the partition member 20 is set in contact can be set as appropriate. In the battery stack 1 shown in FIG. 1, the constraint force acting in the X direction has to be applied to the single battery 10. When the partition member 20 is set in contact with the battery case 13, if the side surface SF of the battery case 13 is located in the Y-Z plane, it is easy to cause the constraint force in the X direction on the single battery 10.

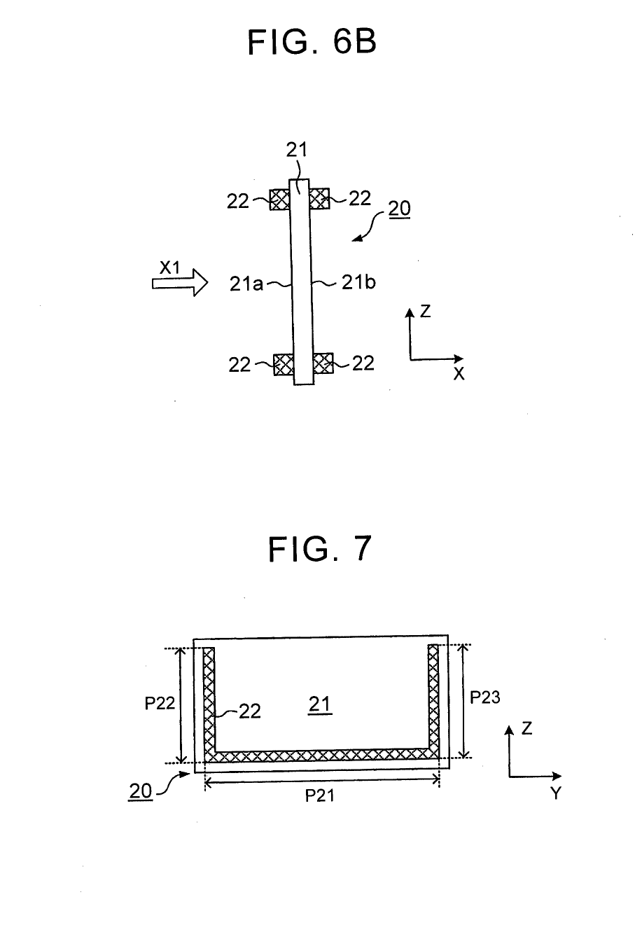

The structure of the partition member 20 is explained with reference to FIGS. 6A and 6B. FIG. 6A is a diagram of the partition member 20 viewed from the X direction (a direction of an arrow X1 in FIG. 6B). FIG. 6B is a VIB-VIB sectional view of FIG. 6A.

The partition member 20 includes a main body section 21 and protrusion sections 22. The main body section 21 is disposed in the Y-Z plane and is opposed to the side surface SF of the battery case 13 in the X direction. The protrusion sections 22 are provided on two side surfaces 21a and 21b of the main body section 21 and project in the X direction from the side surfaces 21a and 21b. The side surfaces 21a and 21b are both the end faces of the main body section 21 in the X direction.

The distal ends of the protrusion sections 22 are in contact with the contact regions B2 of the side surfaces SF. Consequently, the side surfaces 21a and 21b of the main body section 21 are separated from the side surfaces SF of the battery case 13. That is, spaces are formed between the side surfaces 21a and 21b and the side surfaces SF.

As shown in FIG. 6A, the protrusion section 22 includes two regions P11 and P12 extending in the Y direction and two regions P13 and P14 extending in the Z direction in the Y-Z plane. The region P11 of the protrusion section 22 is in contact with a region located above the noncontact region B1 (a part of the contact region B2) in the contact region B2. The region P12 of the protrusion section 22 is in contact with a region located below the noncontact region B1 (a part of the contact region B2) in the contact region B2.

The regions P13 and P14 of the protrusion section 22 are in contact with the contact region B2 in positions sandwiching the noncontact region B1 in the Y direction.

Both the ends of the region P11 in the Y direction are linked to the two regions P13 and P14. Both the ends of the region P12 in the Y direction are linked to the two regions P13 and P14. Therefore, the protrusion section 22 is in contact with the contact region B2 in a position surrounding the noncontact region B1.

In the regions P11 to P14, the height (the length in the X direction) of the protrusion section 22 is equal. Therefore, when the distal end of the protrusion section 22 is in contact with the side surface SF (the contact region B2) of the battery case 13, the side surface SF of the single battery 10 is disposed in parallel to the Y-Z plane. By locating the side surface SF of the single battery 10 in parallel to the Y-Z plane, the constraint force in the X direction can be applied to the single battery 10.

In this embodiment, the region A of the power generation element 14 expands and contracts according to charging and discharging of the power generation element 14 and a temperature change of the power generation element 14. The noncontact region B1 of the side surface SF is deformed according to the expansion and the contraction of the region A. In this embodiment, the deformation of the noncontact region B1 can be allowed by using the space formed between the main body section 21 of the partition member 20 and the side surface SF. For example, when the noncontact region B1 is deformed in a direction toward the main body section 21 according to the expansion of the power generation element 14, the noncontact region B1 can be deformed in the space. When the power generation element 14 contracts after expanding, the noncontact region B1 is only deformed in the space.

The protrusion section 22 of the partition member 20 is in contact with the contact region B2 different from the noncontact region B1. Therefore, the deformation of the noncontact region B1 involved in the expansion and the contraction of the power generation element 14 less easily acts on a contact portion of the partition member 20 and the single battery 10. That is, even if the expansion and the contraction of the power generation element 14 occur, since the contact region B2 is less easily deformed, the constraint force acting on the contact region B2 can be continued to be maintained fixed.

The coupling member 32 is coupled to the pair of end plates 31, whereby an interval between the pair of end plates 31 is fixed. When the partition member 20 is in contact with only the noncontact region B1, the constraint force applied to the single battery 10 (the noncontact region B1) from the partition member 20 decreases when the power generation element 14 contracts. On the other hand, irrespective of whether the partition member 20 is in contact with the contact region B2, when the partition member 20 is in contact with the noncontact region B1, a force for increasing the interval between the pair of end plates 31 is generated when the power generation element 14 expands. In this case, an excessive load is sometimes applied to the end plates 31.

In this embodiment, as explained above, the constraint force to the single battery 10 can be maintained fixed. Therefore, it is possible to suppress the deficiencies explained above from occurring. Note that, it is also conceivable to improve the strength of the end plates 31 assuming that the excessive load is applied to the end plates 31. However, according to this embodiment, it is also unnecessary to improve the strength of the end plates 31.

In this embodiment, when the power generation element 14 expands, the noncontact region B1 is deformed in the space formed between the main body section 21 of the partition member 20 and the side surface SF. That is, even if the noncontact region B1 is deformed according to the expansion of the power generation element 14, the noncontact region B1 is prevented from coming into contact with the main body section 21.

In this case, a constraint force does not act on the noncontact region B1. The constraint force acting on the noncontact region B1 is smaller than the constraint force acting on the contact region B2. In other words, the constraint force acting on the contact region B2 is larger than the constraint force acting on the noncontact region B1.

Depending on the height (the length in the X direction) of the protrusion section 22 and the expansion (i.e., an expansion amount in the X direction) of the power generation element 14, the noncontact region B1 sometimes comes into contact with the main body section 21. In this case, a constraint force acts on the noncontact region B1 from the main body section 21. However, the constraint force acting on the noncontact region B1 is smaller than the constraint force acting on the contact region B2. In other words, the constraint force acting on the contact region B2 is larger than the constraint force acting on the noncontact region B1. In this case as well, when the power generation element 14 expands, it is possible to suppress an excessive load from being applied to the end plate 31.

In the partition member 20 shown in FIG. 6A, the protrusion section 22 is in contact with a part of the contact region B2. However, the protrusion section 22 can be set in contact with the entire contact region B2. When the protrusion section 22 is set in contact with a part of the contact region B2, a position where the protrusion section 22 is set in contact with the contact region B2 is desirably separated from the noncontact region B1. It is also likely that a boundary portion between the noncontact region B1 and the contact region B2 is deformed according to the deformation of the noncontact region B1. Therefore, in the Y-Z plane, by moving the contact position of the protrusion section 22 with the contact region B2 away from the noncontact region B1, the contact region B2 can be less easily affected by the deformation of the noncontact region B1 in the contact position.

In FIG. 6B, the protrusion sections 22 are provided on the two side surfaces 21a and 21b of the main body section 21. However, the protrusion section 22 can also be provided on only one of the side surfaces 21a and 21b. The side surface on which the protrusion section 22 is not provided is in contact with the side surface SF of the battery case 13. In this case, in one single battery 10, the protrusion section 22 is in contact with one side surface SF and the main body section 21 is in contact with the other side surface SF. On the side where the protrusion section 22 is disposed, as explained above, the space is formed between the side surface SF and the main body section 21. By using the space, the expansion and the contraction of the power generation element 14 can be allowed. The partition member 20 can be less easily affected by the expansion and the contraction of the power generation element 14.

The structure of the partition member 20 is not limited to the structure shown in FIGS. 6A and 6B. Several structures (examples) in the partition member 20 are explained below. In the following explanation, components having functions same as the functions of the components of the partition member 20 explained with reference to FIGS. 6A and 6B are denoted by the same reference numerals and signs. In the structures explained below, it is possible to obtain effects same as the effects of the structure shown in FIGS. 6A and 6B. FIGS. 7 to 12 referred to below are figures corresponding to FIG. 6A.

In the partition member 20 shown in FIG. 7, the protrusion section 22 includes a region P21 extending in the Y direction and two regions P22 and P23 extending in the Z direction in the Y-Z plane. Both the ends of the region P21 in the Y direction are respectively linked to the regions P22 and P23. The region P21 is in contact with a region located below the noncontact region B1 in the contact region B2. The regions P22 and P23 are in contact with the contact region B2 in positions sandwiching the noncontact region B1 in the Y direction.

In the regions P21 to P23, the height (the length in the X direction) of the protrusion section 22 is equal. Consequently, the protrusion section 22 (the regions P21 to P23) is in contact with the contact region B2, whereby the side surface SF of the single battery 10 can be located in parallel to the Y-Z plane. Consequently, the constraint force in the X direction can be applied to the single battery 10.

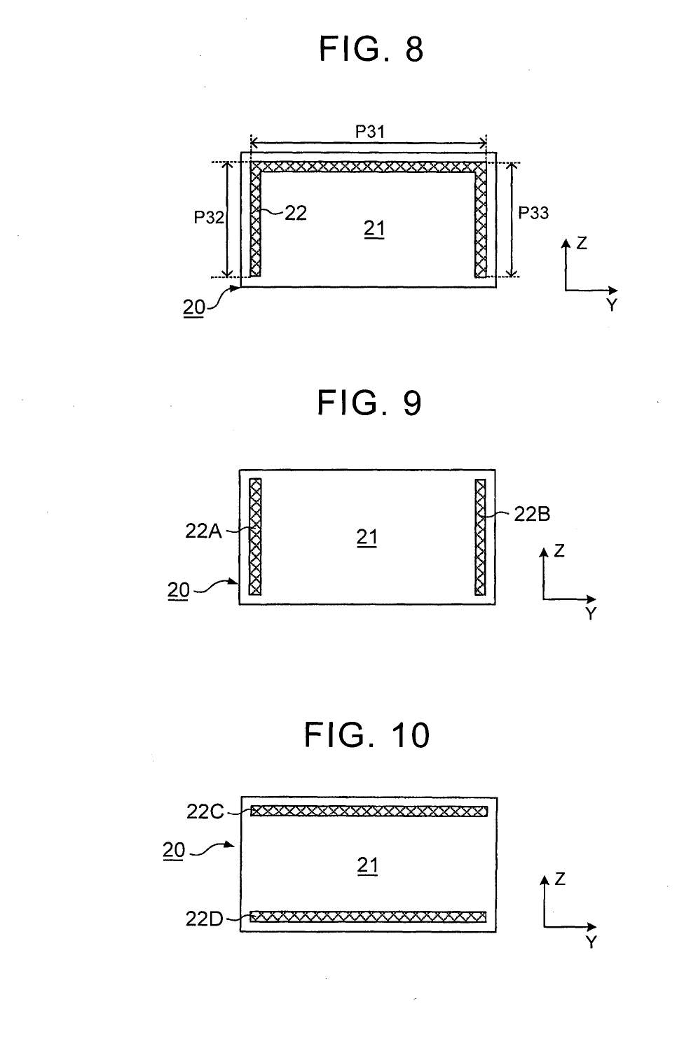

In the partition member 20 shown in FIG. 8, the protrusion section 22 includes a region P31 extending in the Y direction and two regions P32 and P33 extending in the Z direction in the Y-Z plane. Both the ends of the region P31 in the Y direction are respectively linked to the regions P32 and P33. The region P31 is in contact with a region located above the noncontact region B1 in the contact region B2. The regions P32 and P33 are in contact with the contact region B2 in positions sandwiching the noncontact region B1 in the Y direction.

In the regions P31 to P33, the height (the length in the X direction) of the protrusion section 22 is equal. Consequently, the protrusion section 22 (the regions P31 to P33) is in contact with the contact region B2, whereby the side surface SF of the single battery 10 can be located in parallel to the Y-Z plane. Consequently, the constraint force in the X direction can be applied to the single battery 10.

The partition member 20 shown in FIG. 9 includes two protrusion sections 22 (22A and 22B) extending in the Z direction in the Y-Z plane. In the partition member 20 shown in FIGS. 6A to 8, the one protrusion section 22 is used. However, in the partition member 20 shown in FIG. 9, the two protrusion sections 22A and 22B are used. The two protrusion sections 22A and 22B are in contact with the contact region B2 in positions sandwiching the noncontact region B1 in the Y direction.

The heights (the lengths in the X direction) of the two protrusion sections 22A and 22B are equal to each other. Consequently, the two protrusion sections 22A and 22B are in contact with the contact region B2, whereby the side surface SF of the single battery 10 can be located in parallel to the Y-Z plane. Consequently, the constraint force in the X direction can be applied to the single battery 10.

When the partition member 20 shown in FIG. 9 is used, a heat exchange medium (gas such as the air or liquid) for adjusting the temperature of the single battery 10 can be fed to the space formed between the main body section 21 and the single battery 10. Specifically, the heat exchange medium can be fed along the Z direction. Consequently, the temperature of the single battery 10 can be adjusted by bringing the heat exchange medium into contact with the side surface SF of the single battery 10. To suppress the temperature of the single battery 10 from dropping, a heat exchange medium having temperature higher than the temperature of the single battery 10 only has to be used. On the other hand, to suppress the temperature of the single battery 10 from rising, a heat exchange medium having temperature lower than the temperature of the single battery 10 only has to be used.

Note that, when the partition members 20 shown in FIGS. 6A to 8 are used, the heat exchange medium for adjusting the temperature of the single battery 10 can be brought into contact with a surface other than the side surface SF in the battery case 13. As the surface other than the side surface SF, there are surfaces sandwiching the power generation element 14 in the Z direction and surfaces sandwiching the power generation element 14 in the Y direction. The heat exchange medium for temperature adjustment can be brought into contact with at least a part of these surfaces. Note that, even when the partition member 20 shown in FIG. 9 is used, the heat exchange medium for temperature adjustment can be brought into contact with the surface other than the side surface SF.

The partition member 20 shown in FIG. 10 includes two protrusion sections 22 (22C and 22D) extending in the Y direction in the Y-Z plane. The two protrusion sections 22C and 22D are in contact with the contact region B2 in positions sandwiching the noncontact region B1 in the Z direction. The heights (the lengths in the X direction) of the two protrusion sections 22C and 22D are equal to each other. Therefore, the two protrusion sections 22C and 22D are in contact with the contact region B2, whereby the side surface SF of the single battery 10 can be located in parallel to the Y-Z plane. Consequently, the constraint force in the X-direction can be applied to the single battery 10.

When the partition member 20 shown in FIG. 10 is used, the heat exchange medium for adjusting the temperature of the single battery 10 can be fed to the space formed between the main body section 21 and the single battery 10. Specifically, the heat exchange medium can be fed along the Y direction. Consequently, the temperature of the single battery 10 can be adjusted by bringing the heat exchange medium into contact with the side surface SF of the single battery 10. Note that, even when the partition member 20 shown in FIG. 10 is used, the heat exchange medium for temperature adjustment can be brought into contact with the surface other than the side surface SF.

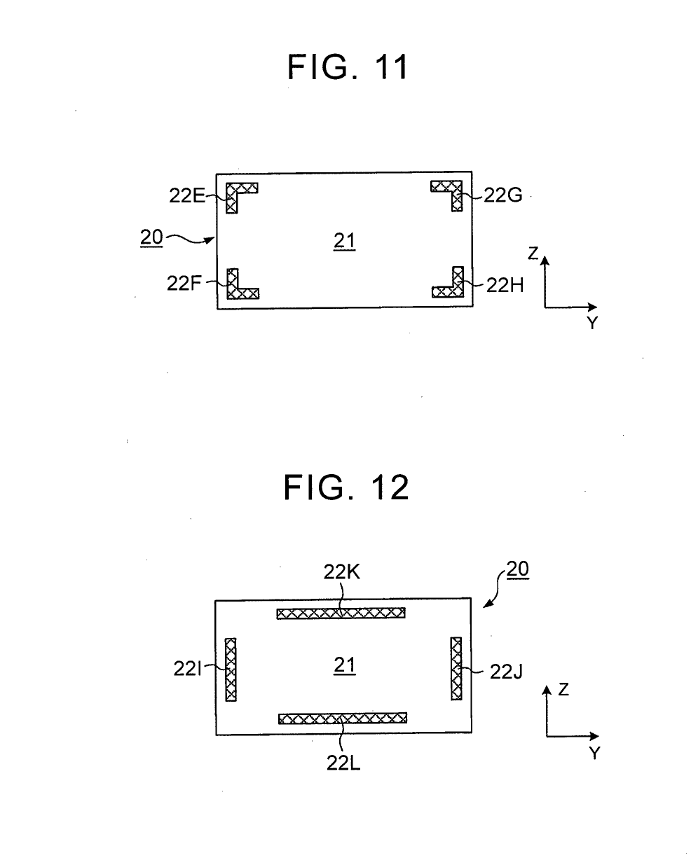

The partition member 20 shown in FIG. 11 includes four protrusion sections 22 (22E, 22F, 22G, and 22H). The protrusion sections 22E to 22H include regions extending in the Y direction and regions extending in the Z direction in the Y-Z plane. The protrusion sections 22E to 22H are in contact with the contact region B2 in positions corresponding to the four corners of the noncontact region B1. The heights (the lengths in the X direction) of the four protrusion sections 22E to 22H are equal to one another. Therefore, by setting the four protrusion sections 22E to 22H in contact with the contact region B2, the side surface SF of the single battery 10 can be located in parallel to the Y-Z plane. Consequently, the constraint force in the X direction can be applied to the single battery 10.

When the partition member 20 shown in FIG. 11 is used, the heat exchange medium for adjusting the temperature of the single battery 10 can be fed to the space formed between the main body section 21 and the single battery 10. Specifically, the heat exchange medium can be fed along the Z direction and the Y direction. Consequently, the temperature of the single battery 10 can be adjusted by bringing the heat exchange medium into contact with the side surface SF of the single battery 10. Note that, even when the partition member 20 shown in FIG. 11 is used, the heat exchange medium for temperature adjustment can be brought into contact with the surface other than the side surface SF.

The partition member 20 shown in FIG. 12 includes four protrusion sections 22 (22I, 22J, 22k, and 22J). Two protrusion sections 22I and 22J extend in the Z direction in the Y-Z plane. Two protrusion sections 22K and 22L extend in the Y direction in the Y-Z plane. The two protrusion sections 22I and 22J are in contact with the contact region B2 in positions sandwiching the noncontact region B1 in the Y direction. The two protrusion sections 22K and 22L are in contact with the contact region B2 in positions sandwiching the noncontact region B1 in the Z direction. The heights (the lengths in the X direction) of the four protrusion sections 22I to 22L are equal to one another. Therefore, by setting the four protrusion sections 22I to 22L in contact with the contact region B2, the side surface SF of the single battery 10 can be located in parallel to the Y-Z plane. Consequently, the constraint force in the X direction can be applied to the single battery 10.

When the partition member 20 shown in FIG. 12 is used, the heat exchange medium for adjusting the temperature of the single battery 10 can be fed to the space formed between the main body section 21 and the single battery 10. In the Y-Z plane, spaces are formed among the protrusion sections 22I to 22L. Specifically, the spaces are formed between the protrusion sections 22I and 22K, between the protrusion sections 22I and 22L, between the protrusion sections 22L and 22J, and between the protrusion sections 22K and 22J. The heat exchange medium can be supplied to the space formed between the main body section 21 and the single battery 10 and can be discharged from the space formed between the main body section 21 and the single battery 10 using the spaces. Consequently, the temperature of the single battery 10 can be adjusted by bringing the heat exchange medium into contact with the side surface SF of the single battery 10. Note that, even when the partition member 20 shown in FIG. 12 is used, the heat exchange medium for temperature adjustment can be brought into contact with the surface other than the side surface SF.

In the partition members 20 shown in FIGS. 7 to 12, the protrusion section 22 can be provided on the two side surfaces 21a and 21b in the same manner as shown in FIG. 6B or can be provided on only one of the side surfaces 21a and 21b. In the structures shown in FIGS. 7 to 12, as explained above, a position where the protrusion section 22 is set in contact with the contact region B2 is desirably separated from the noncontact region B1.

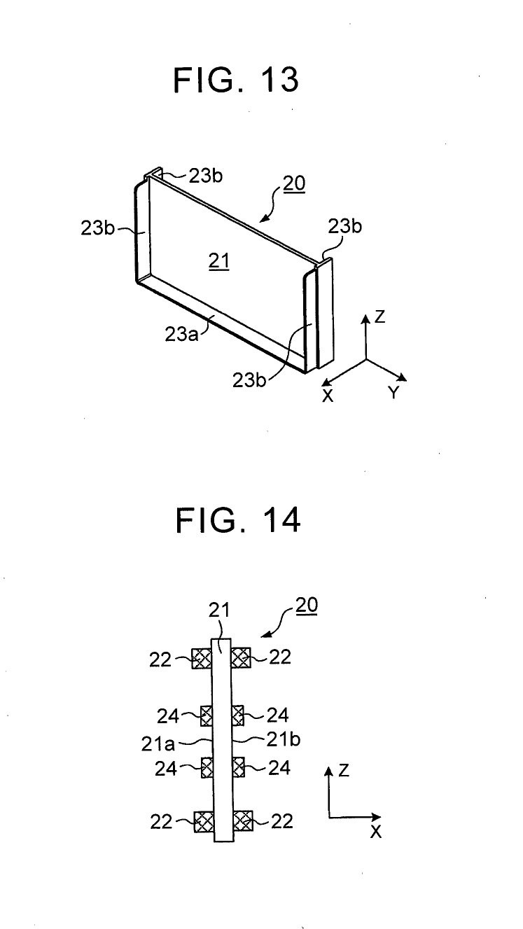

On the other hand, as shown in FIG. 13, flanges 23a and 23b can be provided at the outer edge of the partition member 20. In FIG. 13, the protrusion section 22 is not shown. The protrusion section 22 explained with reference to each of FIGS. 6A to 12 can be provided in the partition member 20 shown in FIG. 13.

The flanges 23a and 23b project in the X direction from the main body section 21. In the Y-Z plane, the flange 23a extends in the Y direction and the flanges 23b extend in the Z direction. Two flanges 23b are respectively linked to both the ends of the flange 23a in the Y direction. Note that the flanges 23a and 23b do not have to be linked.

By placing the bottom surface of the single battery 10 on the upper surface of the flange 23a, the single battery 10 can be positioned in the Z direction. The bottom surface of the single battery 10 is a surface on the opposite side in the Z direction with respect to the upper surface of the single battery 10 on which the positive electrode terminal 11 and the negative electrode terminal 12 are provided. By disposing the single battery 10 between the two flanges 23b, the single battery 10 can be positioned in the Y direction.

Consequently, the single battery 10 can be positioned in the Y-Z plane with respect to the partition member 20. If the single battery 10 can be positioned with respect to the partition member 20, the protrusion sections 22 shown in FIGS. 6A to 12 can be set in contact with the contact region B2 without shifting from a desired position.

Note that, in the partition member 20 shown in FIG. 13, the single battery 10 is positioned in the Y direction by using the two flanges 23b. However, the positioning of the single battery 10 is not limited to this. That is, the single battery 10 can be positioned in the Y direction using only one of the two flanges 23b. The single battery 10 can be positioned in the Y direction by setting the single battery 10 in contact with one flange 23b.

In the embodiment explained above, the partition member 20 includes the main body section 21 and the protrusion section 22. However, the partition member 20 is not limited to this. Specifically, the main body section 21 can be omitted. That is, the partition member 20 can be configured by only the protrusion sections 22 shown in FIGS. 6A to 12. The partition member 20 (the protrusion section 22) only has to be fixed in the contact region B2 of the battery case 13. As means for fixing the partition member 20 (the protrusion section 22), for example, an adhesive can be used.

In this case, both the end faces of the partition member 20 (the protrusion section 22) in the X direction can be respectively in contact with the contact regions B2 of two battery cases 13 adjacent to each other in the X direction. Consequently, a space is formed between the two battery cases 13 adjacent to each other in the X direction. By using this space, as in this embodiment, the deformation of the noncontact region B1 involved in the expansion and the contraction of the power generation element 14 can be allowed. In this case, a constraint force does not act on the noncontact region B1 from the partition member 20 (the protrusion section 22). The constraint force acting on the noncontact region B1 is smaller than the constraint force acting on the contact region B2. In other words, the constraint force acting on the contact region B2 is larger than the constraint force acting on the noncontact region B1.

On the other hand, in the configuration in which the partition member 20 includes the main body section 21 and the protrusion sections 22, as shown in FIG. 14, protrusion sections 24 different from the protrusion sections 22 can be provided in the main body section 21. FIG. 14 is a diagram corresponding to FIG. 6B. Note that, in the configuration shown in FIG. 14, the protrusion sections 24 are provided on the two side surfaces 21a and 2 lb of the main body section 21. However, the protrusion sections 24 only have to be provided on at least one of the side surfaces 21a and 21b.

The protrusion section 24 shown in FIG. 14 is opposed to the noncontact region B1 in the X direction. The height (the length in the X direction) of the protrusion section 24 is smaller than the height (the length in the X direction) of the protrusion section 22. As explained above, the protrusion section 24 can be provided taking into account, for example, easiness of temperature adjustment of the single battery 10 by the heat exchange medium in feeding the heat exchange medium to the space formed between the main body section 21 and the single battery 10. Specifically, when the heat exchange medium is fed to the space between the main body section 21 and the single battery 10, the heat exchange medium can be caused to collide with the protrusion section 24 and a turbulent flow can be generated in a flow of the heat exchange medium. Consequently, heat exchange between the heat exchange medium and the single battery 10 (the side surface SF) can be facilitated. It is easy to adjust the temperature of the single battery.

Since the height of the protrusion section 24 is smaller than the height of the protrusion section 22, even if the noncontact region B1 is deformed according to the expansion of the power generation element 14, the noncontact region B1 less easily comes into contact with the protrusion section 24. If the power generation element 14 expands and contracts in a range in which the noncontact region B1 does not come into contact with the protrusion section 24, a constraint force does not act on the noncontact region B1. Consequently, the constraint force acting on the noncontact region B1 is smaller than the constraint force acting on the contact region B2. In other words, the constraint force acting on the contact region B2 is larger than the constraint force acting on the noncontact region B1.

On the other hand, the noncontact region B1 comes into contact with the protrusion section 24 according to the expansion of the power generation element 14, whereby a constraint force sometimes acts on the noncontact region B1. In this case as well, because of the difference between the heights of the protrusion sections 23 and 24, the constraint force acting on the noncontact region B1 is smaller than the constraint force acting on the contact region B2. In other words, the constraint force acting on the contact region B2 is larger than the constraint force acting on the noncontact region B1. Consequently, when the power generation element 14 expands, it is possible to suppress an excessive load from being applied to the end plates 31.

Positions where the coupling members 32 are disposed are explained.

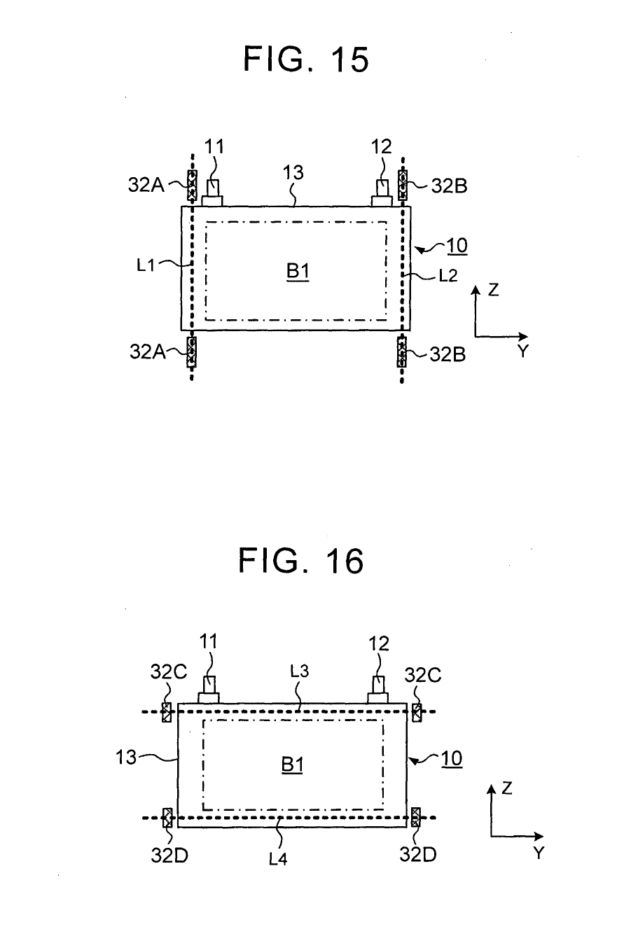

In the battery stack 1 in this embodiment, the coupling members 32 (32A and 32B) are disposed in positions shown in FIG. 15. A region surrounded by an alternate long and short dash line in FIG. 15 indicates the noncontact region B1. In the side surface SF of the battery case 13, a region other than the noncontact region B1 is the contact region B2.

The sectional shape of the coupling members 32A and 32B in the Y-Z plane is formed in a rectangular shape. Specifically, in the coupling members 32A and 32B, the length in the Z direction is larger than the length in the Y direction. Note that, in the coupling members 32A and 32B, the length in the Y direction can also be set larger than the length in the Z direction. The sectional shape of the coupling members 32A and 32B in the Y-Z plane may be a shape other than the rectangular shape and may be, for example, a circular shape.

A pair of coupling members 32A is disposed in positions sandwiching the single battery 10 in the Z direction. In the Y-Z plane, a part of the contact region B2 extends from one coupling member 32A to the other coupling member 32A. In other words, in the Y-Z plane, only the contact region B2 is located and the noncontact region B1 is not located between the pair of coupling members 32A. Note that, in FIG. 15, the pair of coupling members 32A is disposed in an X-Z plane (in the same plane). However, the disposition of the pair of coupling members 32A is not limited to this. One coupling member 32A may be shifted in the Y direction with respect to the other coupling member 32A.

A pair of coupling members 32B is disposed in positions sandwiching the single battery 10 in the Z direction. In the Y-Z plane, a part of the contact region B2 extends from one coupling member 32B to the other coupling member 32B. In other words, in the Y-Z plane, only the contact region B2 is located and the noncontact region B1 is not located between the pair of coupling members 32B. Note that, in FIG. 15, the pair of coupling members 32B is disposed in the X-Z plane (in the same plane). However, the disposition of the pair of coupling members 32B is not limited to this. One coupling member 32B may be shifted in the Y direction with respect to the other coupling member 32B.

In the Y-Z plane, the region P13 of the protrusion section 22 shown in FIG. 6A extends on a straight line (an imaginary line extending in the Z direction) L1 that connects the pair of coupling members 32A shown in FIG. 15. In the Y-Z plane, the region P14 of the protrusion section 22 shown in FIG. 6A extends on a straight line (an imaginary line extending in the Z direction) L2 that connects the pair of coupling members 32B shown in FIG. 15.

In FIG. 15, the straight line L1 is a straight line that connects the centers of the coupling members 32A in the Y direction. The straight line L2 is a straight line that connects the centers of the coupling members 32B in the Y direction. The straight lines L1 and L2 shown in FIG. 15 are examples. Since the coupling member 32A has width in the Y direction, the straight line that connects the pair of coupling members 32A includes a straight line other than the straight line L1. The same holds true about the straight line L2. The region P13 only has to extend on the straight line (including the straight line L1) that connects the pair of coupling members 32A. The region P14 only has to extend on the straight line (including the straight line L2) that connects the pair of coupling members 32B.

By locating the regions P13 and P14 of the protrusion section 22 in this way, it is easy to cause a constraint force generated by the end plates 31 and the coupling members 32A and 32B to act on the protrusion section 22. This is specifically explained below.

A constraint force generated by coupling the pair of coupling members 32A to the pair of end plates 31 mainly acts in the plane (the X-Z plane) including the pair of coupling members 32A. The region P13 of the protrusion section 22 extends on the straight line L1. The straight line L1 is located in the plane (the X-Z plane) including the pair of coupling members 32A. Consequently, it is easy to cause the constraint force generated by coupling the pair of coupling members 32A to the pair of end plates 31 to act on the region P13. Because of the same reason, it is easy to cause a constraint force generated by coupling the pair of coupling members 32B to the pair of end plates 31 to act on the region P14 of the protrusion section 22.

For example, when the region P13 of the protrusion section 22 shifts in the Y direction with respect to the straight line L1 that connects the pair of coupling members 32A, it is hard to cause the constraint force generated using the pair of coupling members 32A to act on the region P13. A constraint force acting on the region P13 decreases. In this case, when it is attempted to cause a constraint force equivalent to the constraint force in this embodiment to act on the region P13, the constraint force generated using the pair of coupling members 32A has to be increased. According to this embodiment, it is possible to apply a predetermined constraint force to the protrusion section 22 without excessively increasing the constraint force generated using the pair of coupling members 32A or the pair of coupling members 32B.

From the viewpoint of being less easily affected by the action due to the expansion and the contraction of the power generation element 14, positions where the coupling members 32 (32A and 32B) are disposed can be set as appropriate. However, from the viewpoint of easily causing the constraint force to act on the protrusion section 22, the protrusion sections 22 (the regions P13 and P14) are desirably disposed as explained above.

When the coupling members 32A and 32B are disposed in the positions shown in FIG. 15, the partition members 20 shown in FIGS. 7 to 9, FIG. 11, and FIG. 12 can also be used. Consequently, as in the case in which the partition member 20 shown in FIG. 6A is used, it is easy to cause the constraint force generated by coupling the coupling members 32A and 32B to the end plates 31 to act on the protrusion section 22.

In the partition member 20 shown in FIG. 7 (or FIG. 8), in the Y-Z plane, the region P22 (or the region P32) extends on the straight line L1 that connects the pair of coupling members 32A and the region P23 (or the region P33) extends on the straight line L2 that connects the pair of coupling members 32B. In the partition member 20 shown in FIG. 9 (or FIG. 12), in the Y-Z plane, the protrusion section 22A (or the protrusion section 22I) extends on the straight line L1 that connects the pair of coupling members 32A and the protrusion section 22B (or the protrusion section 22J) extends on the straight line L2 that connects the pair of coupling members 32B

In the partition member 20 shown in FIG. 11, in the Y-Z plane, a part (regions extending in the Z direction) of the protrusion sections 22E and 22F extends on the straight line L1 that connects the pair of coupling members 32A. In the Y-Z plane, a part (regions extending in the Z direction) of the protrusion sections 22G and 22H extends on the straight line L2 that connects the pair of coupling members 32B.

On the other hand, coupling members 32C and 32D can also be arranged as shown in FIG. 16. A region surrounded by an alternate long and short dash line in FIG. 16 indicates the noncontact region B1. A region other than the noncontact region B1 in the side surface SF of the battery case 13 is the contact region B2.

In FIG. 16, a pair of coupling members 32C is disposed in positions sandwiching the single battery 10 in the Y-direction. In the Y-Z plane, a part of the contact region B2 extends from one coupling member 32C to the other coupling member 32C. In other words, in the Y-Z plane, only the contact region B2 is located and the noncontact region B1 is not located between the pair of coupling members 32C. Note that, in FIG. 16, the pair of coupling members 32C is disposed in the X-Y plane (in the same plane). However, the disposition of the pair of coupling members 32C is not limited to this. One coupling member 32 may be shifted in the Z direction with respect to the other coupling member 32C.

A pair of coupling members 32D is disposed in positions sandwiching the single battery 10 in the Y direction. In the Y-Z plane, a part of the contact region B2 extends from one coupling member 32D to the other coupling member 32D. In other words, in the Y-Z plane, only the contact region B2 is located and the noncontact region B1 is not located between the pair of coupling members 32D. Note that, in FIG. 16, the pair of coupling members 32D is disposed in the X-Y plane (in the same plane). However, the disposition of the pair of coupling members 32D is not limited to this. One coupling member 32D may be shifted in the Z direction with respect to the other coupling member 32D.

When the coupling members 32 (32C and 32D) are disposed as shown in FIG. 16, the partition members 20 shown in FIG. 6A and FIGS. 10 to 12 can be used. Consequently, as in the case explained with reference to FIG. 15, it is easy to cause a constraint force generated by coupling the coupling members 32C and 32D to the end plate 31 to act on the protrusion section 22.

In the partition member 20 shown in FIG. 6A, in the Y-Z plane, the region P11 of the protrusion section 22 extends on a straight line (an imaginary line extending in the Y direction) L3 that connects the pair of coupling members 32C and the region P12 of the protrusion section 22 extends on a straight line (an imaginary line extending in the Y direction) L4 that connects the pair of coupling members 32D. In FIG. 16, the straight line L3 is a straight line that connects the centers of the coupling members 32C in the Z direction. The straight line L4 is a straight line that connects the centers of the coupling members 32D in the Z direction.

In the partition member 20 shown in FIG. 10, in the Y-Z plane, the protrusion section 22C extends on the straight line L3 that connects the pair of coupling members 32C and the protrusion section 22D extends on the straight line L4 that connects the pair of coupling members 32D.

In the partition member 20 shown in FIG. 11, in the Y-Z plane, a part (regions extending in the Y direction) of the protrusion sections 22E and 22G extends on the straight line L3 that connects the pair of coupling members 32C. In the Y-Z plane, a part (regions extending in the Y direction) of the protrusion sections 22F and 22H extends on the straight line L4 that connects the pair of coupling members 32D. In the partition member 20 shown in FIG. 12, in the Y-Z plane, the protrusion section 22K extends on the straight line L3 that connects the pair of coupling members 32C and the protrusion section 22L extends on the straight line L4 that connects the pair of coupling members 32D.

The straight lines L3 and L4 shown in FIG. 16 are examples. Since the coupling member 32C has width in the Z direction, the straight line that connects the pair of coupling members 32C includes a straight line other than the straight line L3. The same holds true about the straight line L4. The protrusion section 22 only has to extend on the straight line (including the straight line L3) that connects the pair of coupling members 32C while being in contact with the contact region B2. The protrusion section 22 only has to extend on the straight line (including the straight line L4) that connects the pair of coupling members 32D while being in contact with the contact region B2.

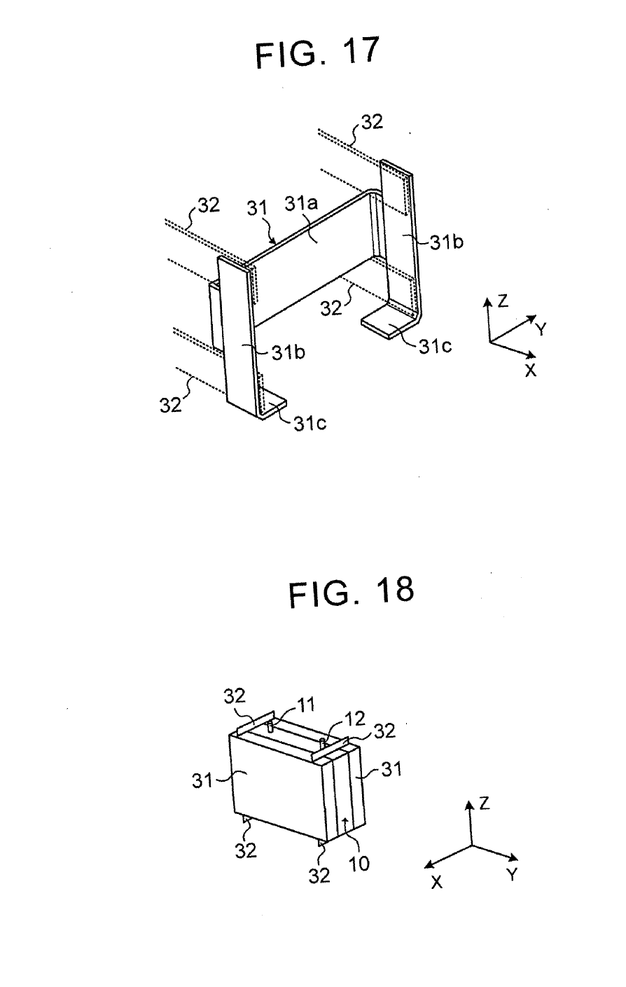

When the coupling members 32 shown in FIGS. 15 and 16 are used, the end plate 31 shown in FIG. 17 can be used.

As shown in FIG. 17, the end plate 31 includes a main body section 31a, a pair of flanges 31b, and a pair of leg sections 31c. The main body section 31a is in contact with the side surface SF of the single battery 10. The pair of flanges 31b is provided on the opposite side of the side of the single battery 10 with respect to the main body section 31a. The coupling members 32 are coupled to the upper end portions and the lower end portions of the flanges 31b.

When the coupling members 32A and 32B are disposed as shown in FIG. 15, the pair of coupling members 32A is coupled to one flange 31b and the pair of coupling members 32B is coupled to the other flange 3 lb. When the coupling members 32C and 32D are disposed as shown in FIG. 16, the pair of coupling members 32C is respectively coupled to the upper end portions of the pair of flanges 3 lb and the pair of coupling members 32D is respectively coupled to the lower end portions of the pair of flanges 31b.

As shown in FIG. 17, a portion where a portion where the flange 31b and the coupling member 32 overlap each other is a portion where the flange 31b and the coupling member 32 are coupled. The leg sections 31c are provided at the lower end portions of the flanges 31b. The leg sections 31c are used to fix the end plate 31 (i.e., the battery stack 1). For example, when the battery stack 1 is mounted on a vehicle, the leg sections 31c can be fixed to a vehicle body (e.g., a floor panel).

The main body section 31a of the end plate 31 is in contact with the side surface SF of the single battery 10. Therefore, a protrusion section same as the protrusion section 22 (the structures shown in FIGS. 6A to 12) explained in this embodiment can be provided on a surface opposed to the side surface SF in the main body section 31a. The protrusion section provided in the main body section 31a can be set in contact with the contact region B2.

Consequently, a space can be formed between the single battery 10 and the main body section 31a using the protrusion section. The expansion and the contraction of the power generation element 14 can be allowed using this space. As in this embodiment, a constraint force acting on the side surface SF of the single battery 10 from the main body section 31a can be maintained fixed.

On the other hand, as shown in FIG. 18, a constraint force can be applied to one single battery 10 using the pair of end plates 31. As in this embodiment, the coupling members 32 are coupled to the pair of end plates 31. An electricity storage system in a second invention of this application is configured by the single battery 10, the end plates 31, and the coupling members 32.

In the structure shown in FIG. 18, a protrusion section same as the protrusion section 22 (the structures shown in FIGS. 6A to 12) explained in this embodiment can be provided in at least one of the pair of end plates 31. Specifically, the protrusion section can be provided on a surface opposed to the side surface SF of the single battery 10 in the X direction in the end plate 31. As in this embodiment, the protrusion section provided on the end plate 31 only has to be in contact within the contact region B2. Consequently, it is possible to obtain effects same as the effects in this embodiment.

When the protrusion section (equivalent to the protrusion section 22) is provided on the end plate 31, according to the expansion of the power generation element 14, the noncontact region B1 is sometime in contact with or not in contact with the end plate 31. As in this embodiment, a constraint force acting on the contact region B2 from the end plate 31 (the protrusion section same as the protrusion section 22) needs to be set larger than a constraint force acting on the noncontact region B1 from the end plate 31. Irrespective of the expansion and the contraction of the power generation element 14, the constraint force can be prevented from acting on the noncontact region B1 by preventing the noncontact region B1 from coming into contact with the end plate 31.

On the end plate 31, a protrusion section same as the protrusion section 24 shown in FIG. 14 can also be provided. Even in this case, a constraint force acting on the contact region B2 from the end plate 31 (the protrusion section same as the protrusion section 22) needs to be set larger than a constraint force acting on the noncontact region B1 from the end plate 31 (the protrusion section same as the protrusion section 24). Irrespective of the expansion and the contraction of the power generation element 14, the constraint force can be prevented from acting on the noncontact region B1 by preventing the noncontact region B1 from coming into contact with the protrusion section (equivalent to the protrusion section 24) of the end plate 31.

In the structure shown in FIG. 18 as well, the coupling members 32 can be disposed as explained with reference to FIGS. 15 and 16. The protrusion sections can be disposed along the straight lines L1 and L2 shown in FIG. 15 or the protrusion sections can be disposed along the straight lines L3 and L4 shown in FIG. 16.

1. An electricity storage system comprising:
a plurality of electricity storage elements disposed side by side in a predetermined direction, the electricity storage element each including a power generation element configured to perform charging and discharging and a case configured to house the power generation element, the power generation element including a positive electrode plate in which a positive-electrode active material layer is provided on a current collector and a negative electrode plate in which a negative-electrode active material layer is provided on a current collector, the case including a flat surface orthogonal to the predetermined direction, and the flat surface including a first region opposed to the positive-electrode active material layer and the negative-electrode active material layer in the predetermined direction, and a second region other than the first region;
a partition member disposed between two electricity storage elements adjacent to each other in the predetermined direction;
a pair of end plates disposed in positions sandwiching the plurality of electricity storage elements in the predetermined direction such that the pair of end plates applies a constraint force in the predetermined direction to the plurality of electricity storage elements;
a plurality of coupling members extending in the predetermined direction, the plurality of coupling members being configured to couple the pair of end plates, wherein
the constraint force acting on the second region is larger than the constraint force acting on the first region, on the flat surface of at least one of the two electricity storage elements adjacent to each other in the predetermined direction.

2. The electricity storage system according to claim 1, wherein the constraint force acts on the flat surface from the partition member.

3. The electricity storage system according to claim 2, wherein the partition member is in contact within the second region without being in contact with the first region, on the flat surface of at least one of the two electricity storage elements adjacent to each other in the predetermined direction.

4. The electricity storage system according to claim 3, wherein
the plurality of coupling members include a pair of the coupling members disposed in positions sandwiching the electricity storage elements in a plane orthogonal to the predetermined direction, and
a part of the second region extends from one of the pair of coupling members to the other one of the pair of coupling members in the plane orthogonal to the predetermined direction, and
a region of the partition member that is in contact with the second region extends on a straight line that connects the pair of coupling members in the plane orthogonal to the predetermined direction.

5. The electricity storage system according to claim 3 or claim 3, wherein
the partition member includes a main body section, a flange, and a protrusion section,
the main body section is opposed to the flat surface in the predetermined direction,
the flange is in contact with the case and positions the electricity storage elements in the plane orthogonal to the predetermined direction, and
the protrusion section projects from the main body section in the predetermined direction and is in contact with the second region at a distal end of the protrusion section.

6. The electricity storage system according to claim 1, wherein the constraint force acts on the flat surface from the pair of end plates.

7. The electricity storage system according to claim 6, wherein at least one of the pair of end plates is in contact within the second region without being in contact with the first region, on the flat surface of the electricity storage element.
